(19) United States
(12) Patent Application Publication
(10) Pub. No.: US 2019/0015695 A1
(43) Pub. Date: Jan. 17, 2019

(54) INCLINED REVERSE HYPEREXTENSION EXERCISE DEVICE

(71) Applicant: Louie Simmons, Columbus (US)

(72) Inventor: Louie Simmons, Columbus (US)

(21) Appl. No.: 16/033,423

(22) Filed: Jul. 12, 2018

Related U.S. Application Data
(60) Provisional application No. 62/531,746, filed on Jul. 12, 2017.

(51) Int. Cl. A63B 21/00; A63B 21/068; A63B 23/02

(52) U.S. Cl. CPC A63B 21/4039; A63B 21/00178; A61H 1/02; A63B 23/0233; A61H 2201/1623; A63B 21/068

(57) ABSTRACT

In various embodiments, an exercise machine for the lower body is presented. The machine may include a support structure, having a body support platform inclinable relative to an imaginary line parallel to a support surface. The machine may also include a pendulum pivotably connected to the support structure and depending therefrom. There may also be controls provided that are operably connected the pendulum to regulate the motion of the pendulum upwardly or downwardly while the user's body is disposed on the body support platform and the user's legs engage the pendulum.

### RELATED APPLICATIONS

This application claims the benefit of U.S. Provisional Patent Application 62/531,746; filed Jul. 12, 2017.

### STATEMENT REGARDING FEDERALLY SPONSORED RESEARCH OR DEVELOPMENT

Not applicable.

### TECHNICAL FIELD

The present disclosure relates to the field of sports and exercise equipment, and more particularly, to an inclined reverse hyperextension exercise device.

### BACKGROUND OF THE INVENTION

Back muscle and cartilage injuries, especially in the lower lumbar region of the back are relatively common. Such injuries are especially common in individuals who, for one reason or another, have failed to maintain the conditioning and tone of the muscles that support the lower back. These muscles, the spinal erectors and hip flexor must be maintained in reasonable condition if such muscle and cartilage injuries are to be protected against.

Additionally, once injury has occurred, healing can be promoted by increasing the flow of blood to the injured muscles and the areas surrounding the injury. Unfortunately, the number and density of blood vessels in the lower back area is relatively low. However, exercise is believed by many to stimulate increased blood flow. A draw back to most forms of exercise is the risk or tendency of hyperextension of the already injured muscles thereby aggravating the injury rather than promoting healing of the muscles, cartilage and surrounding tissues.

There have been a number of attempts to exercise the back and other body parts to increase muscle tone and stimulate the flow of blood to muscles and tissues. However, none of the previous attempts have met the exercise needs of individuals who have already sustained lower back injuries or whose lower back areas are too out-of-condition to be able to withstand rigorous exercise. In order for exercise to be of value, it must progressively increase in intensity. A common method of increasing the intensity of an exercise is through the use of increased resistance from static weight additions. However, adding weight to an exercise can increase the hyperextension of lower back muscles. Therefore, weight training is not generally recommended for those suffering from lower back muscle, tissue and cartilage injuries.

There is a need for a method of exercise and an exercise apparatus that avoids hyperextension of lower back muscles while providing for conditioning and muscle tone, and which can increase local blood circulation to injured muscles and tissues in the lower back. There is also a need for an exercise that can permit progressive intensity of the work out to strengthen lower back muscles, tissues and provide increased blood flow to those areas. Additionally, there is a need for a plurality of adjustable features in such a machine, in various embodiments, including but not limited to an inclinable body support platform.

### SUMMARY OF THE INVENTION

A reverse hyperextension exercise machine for the lower body is presented, in various embodiments, having a plurality of adjustable features, including but not limited to an adjustable angulated body support platform.

### BRIEF DESCRIPTION OF THE DRAWINGS

Without limiting the scope of the inclined reverse hyperextension exercise device as claimed below and referring now to the drawings and figures:

FIG. 1 is an elevated perspective view of an embodiment according to the present invention;

FIG. 2 is an elevated perspective detail exploded view of part according to an embodiment of the instant invention;

FIG. 3 is an elevated perspective detail partially exploded view of part of an embodiment according to the instant invention;

FIG. 4 is an elevated perspective view of part of an embodiment according to the instant invention

FIG. 5 is an upwards perspective view of part of an embodiment according to the instant invention; and

FIG. 6 is an elevated perspective partially exploded view of part of an embodiment of the instant invention.

These drawings are provided to assist in the understanding of the exemplary embodiments of the presently disclosed inclined reverse hyperextension exercise device as described in more detail below and should not be construed as unduly limiting the inclined reverse hyperextension exercise device. In particular, the relative spacing, positioning, sizing and dimensions of the various elements illustrated in the drawings are not drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

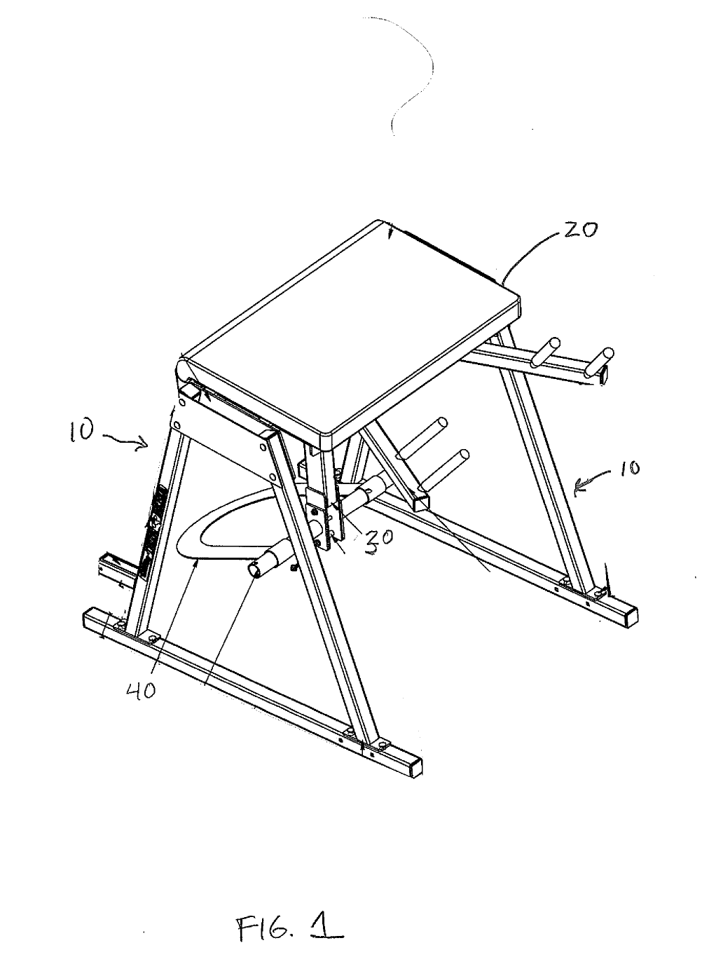

An inclined reverse hyperextension exercise device is seen well in FIGS. 1-6. The preferred embodiments of the device accomplish this by new and novel arrangements of elements and methods that are configured in unique and novel ways and which demonstrate previously unavailable but preferred and desirable capabilities. The detailed description set forth below in connection with the drawings is intended merely as a description of the presently preferred embodiments of the inclined reverse hyperextension exercise device, and is not intended to represent the only form in which the present inclined reverse hyperextension exercise device may be constructed or utilized. The description sets forth the designs, functions, means, and methods of utilizing the inclined reverse hyperextension exercise device in connection with the illustrated embodiments. It is to be understood, however, that the same or equivalent functions and features may be accomplished by different embodiments that are also intended to be encompassed within the spirit and scope of the inclined reverse hyperextension exercise device.

In one set of embodiments, seen well in FIGS. 1-6, support legs may be connected by support cross pieces, and a body support platform (20) to form a support structure (10). The support structure (10) could be constructed without the inclusion of the body support platform (20), and a non-structural body support platform (20) horizontally disposed on the support structure (10). The structural pieces may be made of structural steel sections to provide a very rigid support structure (10). Movement of the support structure (10) during exercise is both dangerous and can cause unneeded anxiety in the person who is performing the exercise. It is preferred that a padding provided on the upper surface of the body support platform (20) for the comfort of the person engaging in the exercise method of the instant invention. In a preferred set of embodiments, the support platform may be inclined to either a somewhat head down, or head up, orientation relative to the floor, to which, therefore, it need not be parallel. Such an incline may be pre-set and fixed by an equipment manufacturer or may be adjustable by a user.

Structural support members add rigidity and strength to the support structure (10) and may also be located to maintain a pivot bar at a point below the body support platform (20). The pivot bar may be located at any location below the body support platform (20). But, it is preferred for optimal implementation of the exercise method that the pivot bar be retained at a point below the location of the waist of the person using the apparatus and at a vertical position near the body support platform (20). In this way, the length of a pendulum (30) can be maximized. The pendulum (30) may be rotatably retained on the pivot bar by pivot means which may be a mere hole in the pendulum (30) or a bearing fitted to the pivot bar. The pendulum (30) may be freely pivotable about the pivot bar from one end.

Located at the other end of pendulum (30) may be a bar which acts as a weight against which the exercise is performed. Additional weights can be added to the bar to permit increasing intensity to the exercise. The bar also provides a place for attaching an adjustable strap. The adjustable strap may be a leather belt which forms a loop through which the exercising person places their ankles. The adjustable strap may provide the flexibility necessary to permit an unrestrained arc of the legs as they move up to the horizontal and back past the vertical during the exercise. This also allows the person to mount the apparatus without the cumbersome situation of having weights attached to the ankles or feet. The static weights of the pendulum (30), bar and weights, if any do not come into play or weight the ankles until the exercise is begun. Adjustability in the strap also permits the loop to be enlarged or reduced for maximum comfort and optimal motion depending on the leg length of the person performing the exercise.

The entire range of the exercise may be envisioned, as seen in U.S. Pat. No. 5,356,359; FIGS. 1-10, incorporated with drawings, only by way of example and not limitation, as if fully rewritten herein. The person to perform the exercise may assume the proper position (face down or equivalently, anterior side down). The torso to the waist is fully supported by the body support platform (20), which in the '359 patent is shown approximately parallel to the floor, although as noted, such a parallel to the ground configuration is not required. For comfort and as an aid to mounting the apparatus, handles which are attached to the support structure (10) may be provided. The person's ankles are shown through the loop of adjustable strap, and weights are shown in place on a bar. The pendulum (30) is at rest in the vertical position straight below the waist of the person.

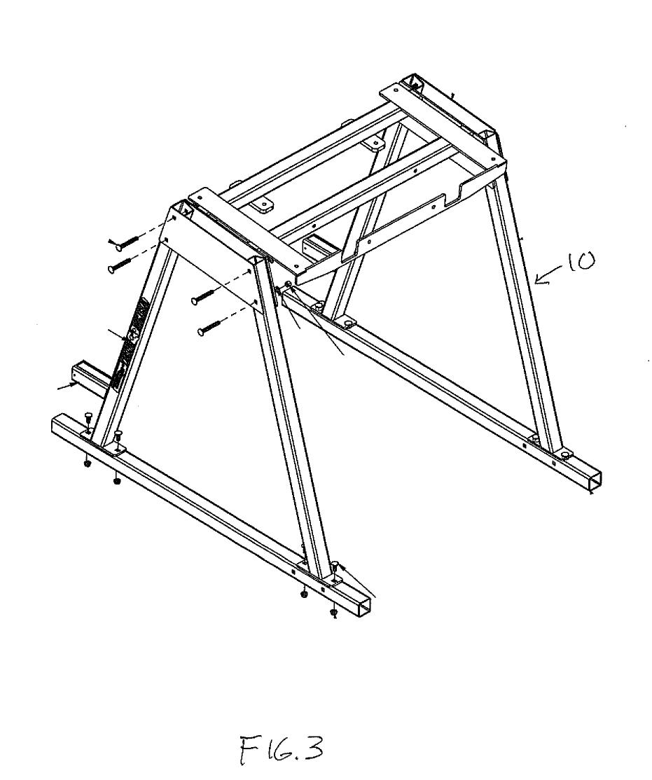

The exercise begins by the person contracting the muscles of the lower back (i.e., spinal erectors and hip flexors) and the gluteus maximus. The legs working against the variable combined weight of the pendulum (30), bar and weights are moved to the horizontal position as shown in FIG. 3 of the '359 patent.

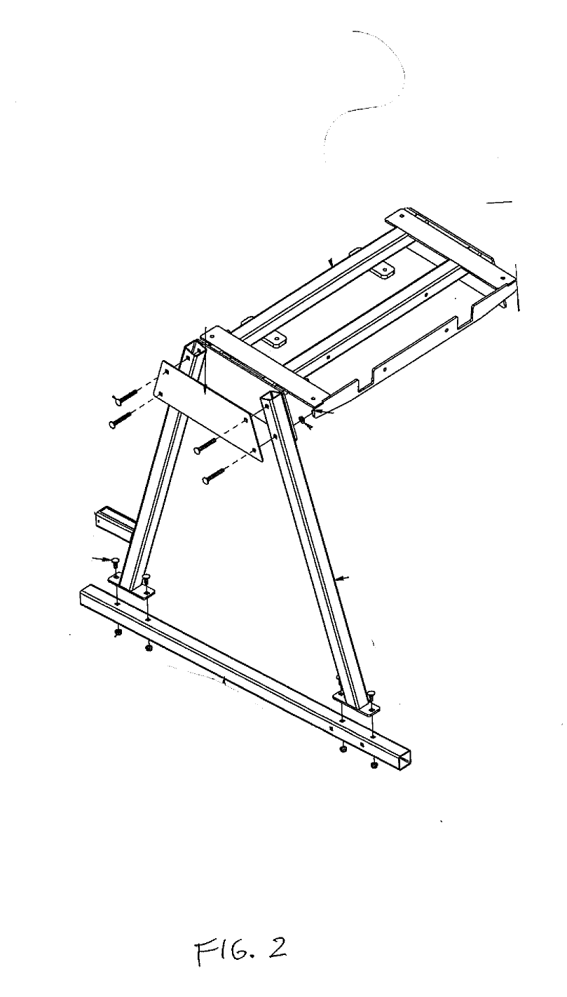

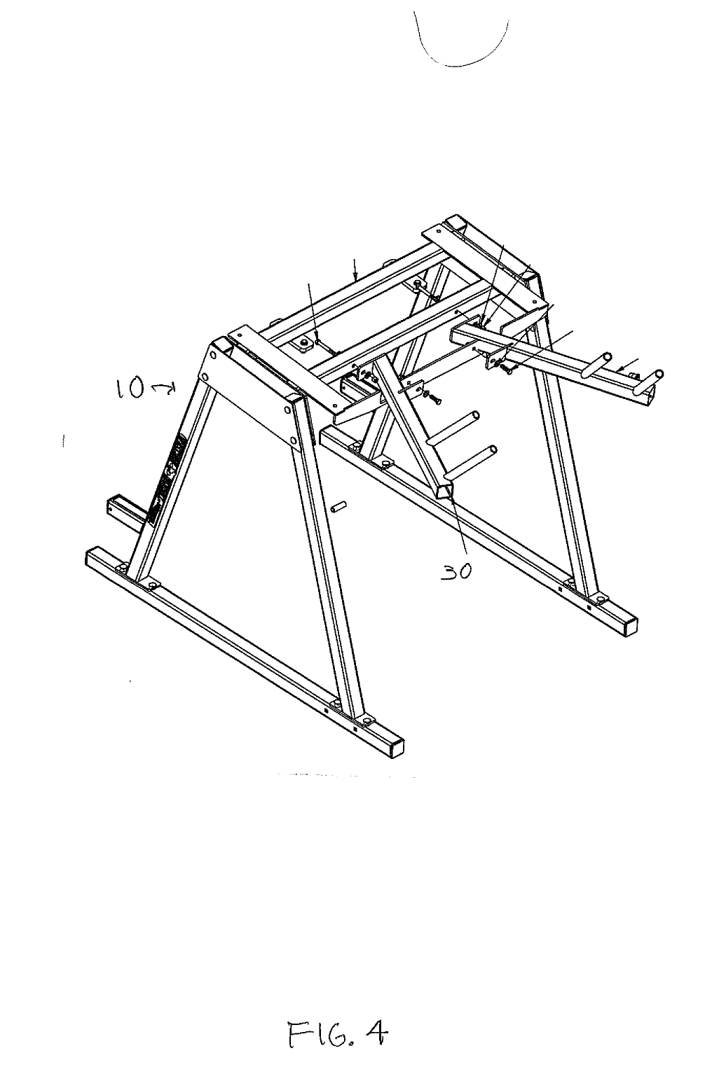

The person then lowers the legs, not by simply relaxing the muscles but by lowering the legs using all the muscle groups of the upper legs and lower back. The legs are fully lowered to at least the vertical and then are pushed by muscle action past the vertical as shown in FIG. 4 of the '359 patent. After the person has pushed the legs as far past the vertical as they can, the exercise begins again by contracting the muscles and pushing the legs back to the horizontal (i.e., FIG. 2). The exercise is then repeated in the number of iterations desired by the person exercising.

The exercise is best performed as a smooth continuous action through the iterations. At all points in the exercise, the legs and correspondingly the affected muscles only push and are never pulled from one station to the next. The result is that hyperextension of muscles is avoided and the injured muscles of the lower back are permitted to receive an increase flow of blood. Additionally, in a person with an otherwise healthy lower back, the exercise builds up those lower back muscles thus avoiding future injury.

An additional means that may be provided within the apparatus for assuring the exerciser can only push with the target muscle groups is the addition of a counter weighted pulley and cable system (not shown in the drawings of the '359) that cooperates with the adjustable strap not only to provide resistance to the initial lifting of the legs to the horizontal position, but also provides static weight resistance to returning the legs to and past the vertical starting position in accordance with the exercise as described above.

Increasing lower back strength is also critical to power lifting. The most common injuries to power lifters are those of the lower back. However, by regularly utilizing the exercise of this invention, persons who lift very heavy weights for sport or in competition, also known as power lifters, can train to greater weight levels while avoiding lower back injuries which are not only counter-productive to a proper training program due to lost training time, but also could lead to permanent lower back injuries.

It will be apparent from the above description that this invention provides for a method of exercise and an exercise apparatus for implementing that exercise, in which the muscles of the lower back can be safely exercised and allow for the increased circulation of blood attendant to the proper exercising of all muscles. This increased circulation of blood also promotes healing of damaged or injured muscles and neighboring tissue in the lower back. The exercise further provides for the exercise of these muscles without the danger of hyperextension of the muscles during the exercise. The apparatus also provides for progressively intense work outs by the use of an adjustable strap which engages a variable amount of static weight only after the exercise is commenced.

In another series of embodiments, as exemplified by way of example only and not limitation, as seen in U.S. Pat. No. 6,491,607, including FIGS. 1-5 thereof, support legs are connected by support cross arms and, and a body support platform (20) to form a support structure (10). The support structure (10) could be constructed without the inclusion of the body support platform (20), and a non-structural body support platform (20) then horizontally disposed on the support structure (10). The structural legs and arms may preferably be made of structural steel sections to provide a very rigid support structure (10). Conventional bracing may be added, if needed. Movement of the support structure (10) during the exercise is both dangerous and can cause unneeded anxiety in the person who is performing the exercise. It is preferred that a padding may be provided on the upper surface of the body support platform (20) for the comfort of the person engaging in the exercise method of the instant invention. As discussed above, in a preferred set of embodiments, the support platform may be inclined, or at least be inclinable, to either a somewhat head down, or head up, orientation relative to the floor, to which, therefore, it need not be parallel.

A pivot bar may be located at any location below the body support platform (20), and rotatably retains the pendulum (30). However, for optimal implementation of the exercise method, the pivot bar should be located at a point below the location of the waist of the person using the apparatus and at a vertical position near the body support platform (20). In this way, the length of pendulum (30) can be maximized.

The pendulum (30) may be rotatably retained on the pivot bar by one or more bearings, which may be a mere hole in the pendulum (30), or one or more bearings fitted to the pivot bar. The bearing or bearings may be equivalently mounted on support cross arms, or elsewhere on the supporting structure to thereby rotatably retain the pivot bar. In this case, the pendulum (30) would be fixed to the pivot bar. The pivot bar may be suspended from the body support platform (20), in which case the pivot bar need only be long enough to adequately engage the pendulum (30) by means of the bearing or bearings. In any embodiment, the pendulum (30) is then freely pivotable about the pivot bar from one end of the pendulum (30) in a substantially vertical plane.

Located at the other end of the pendulum (30) is a weight bar which acts as a weight against which the exercise is performed. Additional weights can be added to the weight bar to permit increasing intensity to the exercise. In a first preferred embodiment, the weight bar may be mounted on a frame, which frame is attached to the pendulum (30). By so positioning the weight bar, the person exercising will be forced to expend more energy in moving the pendulum (30) forward (as viewed by the person exercising) from the vertical, because the weight bar, because the weight must be raised to a height above the tangent to the arc defined by the swing of the pendulum (30) than would be the case if the weight bar were positioned on the centerline of the pendulum (30).

A resistance transfer apparatus (40) may be rotatably attached to the pendulum (30) at a connector. The resistance transfer apparatus (40) of a preferred embodiment has a central bar and a mounting assembly, which, in an embodiment, is a fork. The mounting fork may have holes passing thorough the arms of the fork to receive a pivot pin as described below.

In a preferred embodiment, the pendulum (30) may be engaged in sliding fit by a sleeve. The sleeve has a cross-section congruent with that of the pendulum (30) and sized to slideably fit over the pendulum (30) inside the area defined by the members of the frame and the pendulum (30). The pendulum (30) may have two or more adjustment holes which are engaged by an adjustment pin attached to the sleeve, forming an adjustable lock. In this way, the position of the resistance transfer apparatus (40) can be adjusted along the length of the pendulum (30) to accommodate different leg lengths of users. A connector is also attached to the sleeve. The connector is preferably a tube through which a pivot pin can be passed, so that the pin also passes through the holes in the arms of the fork and thus pivotably retains the resistance transfer apparatus (40) on the sleeve. The pin may alternatively be a bolt, screw, cotter pin or other fastener.

The resistance transfer apparatus (40) preferably has two or more pads, which pads are preferably rotatably mounted on resistance bars extending from the central bar of the resistance transfer apparatus (40). The resistance transfer apparatus (40) thus comfortably retains the person's ankles as the exercise is executed. The resistance transfer apparatus (40) may retain the person's legs anywhere along their length, but the optimum position is at the ankles, as shown.

The resistance transfer apparatus (40) and its rotatable connection to the pendulum (30) permits an unrestrained arc of the legs as they move up to the horizontal and back past the vertical during the exercise. This also allows the person to mount the exercise apparatus without the cumbersome situation of having weights attached to the ankles or feet. The static weights of pendulum (30), bar and weights, if any, do not come into play or weight the ankles until the exercise is begun with the pendulum (30) vertical.

In another series of preferred embodiments, the support platform is made adjustable. The second preferred embodiment has an adjustable support platform, also having a padding. The adjustable support platform is disposed to rotate about pivot points. The adjustable support platform is locked into a selected angle with respect to the horizontal by means of at least one adjustment flange. The adjustment flange has locking holes which receive a locking pin. In the second preferred embodiment, the locking pin is held in an engaged position by a spring. The locking pin can thus be pulled outwardly allowing movement of the adjustment flange and therefore the adjustable support platform. When the locking pin is released it will return to engagement with the selected locking hole. The support platform may have a handle.

Such a preferred embodiment may be supported as described for the first preferred embodiment, or supported by support members. The pendulum (30) may be affixed to a pivot bar and held by bearings fitted to the adjustable support platform. The bearings may of course be ball bearings, or simply bushings. A weight bar may be located at the end of the pendulum (30) to support additional weights.

The reader will note that the weight bar may be attached to a frame, exactly as described for the first preferred embodiment. And, a resistance transfer apparatus (40) may be rotatably attached to the pendulum (30). In this such a preferred embodiment will function just as does the first preferred embodiment, except that the angle of the support platform may be adjusted to suit the exercise intensity desired. Additionally, the angle of the support platform may come fixed at some angle other than that which would render the support platform parallel to the floor.

The entire range of the exercise is illustrated in the drawings accompanying the '607 patent. The person performing the exercise may assume the proper position (face down or equivalently, anterior side down), using the first preferred embodiment of the invention. Although this description uses the first preferred embodiment, the second preferred embodiment, having an adjustable support platform could be used equally well. The torso to the waist is fully supported by body support platform (20). For comfort and as an aid to mounting the apparatus handles, attached to the support structure (10) may be provided. Only one handle is shown in the drawings, but in practice, two handles could be used, for grasping by both hands. The person's lower legs may pass through the resistance transfer apparatus (40) and weights are shown in place on the bar. Preferably, the exercise is performed with the ankles passing through the resistance transfer apparatus (40). The pendulum (30) is at rest in the vertical position straight below the waist of the person.

The exercise begins by the person contracting the muscles of the lower back (i.e., spinal erectors and hip flexors) and the gluteus maximus. The legs working against the variable combined weight of pendulum (30), bar and weights are moved through the intermediate position to a final position.

The resistance transfer apparatus (40) pivots about the connector on the sleeve attached to the pendulum (30) so as to keep the pads engaged with the person's legs, preferably at the ankles. The person then lowers the legs, not by simply relaxing the muscles, but by lowering the legs using all the muscle groups of the upper legs and lower back. The legs are fully lowered to at least the vertical and then are pushed by muscle action forward past the vertical. Thus, the total range of motion of the legs is greater than 90 degrees. After the person has pushed the legs as far past the vertical as he can, the exercise begins again by contracting the muscles and pushing the legs back to the horizontal. The exercise is then repeated the number of times desired by the person exercising.

The exercise is best performed as a smooth continuous action through the iterations. At all points in the exercise, the legs and correspondingly the affected muscles only push and are never pulled from one station to the next. The result is that hyperextension of muscles is avoided and the injured muscles of the lower back are permitted to receive an increase flow of blood. Additionally, in a person with an otherwise healthy lower back, the exercise builds up those lower back muscles thus avoiding future injury.

An additional means that may be provided within the apparatus for assuring the exerciser can only push with the target muscle groups is the addition of a counter weighted pulley and cable system (not shown in the drawings) that cooperates with the resistance transfer apparatus (40) not only to provide resistance to the initial lifting of the legs to the horizontal position, but also provides static weight resistance to returning the legs to and past the vertical starting position in accordance with the exercise as described above.

Increasing lower back strength is also critical to power lifting. The most common injuries to power lifters are those of the lower back. However, by regularly utilizing the exercise of this invention, persons who lift very heavy weights for sport or in competition, also known as power lifters, can train to greater weight levels while avoiding lower back injuries which are not only counter-productive to a proper training program due to lost training time, but also could lead to permanent lower back injuries that are also common among power lifters.

It will be apparent from the above description that this invention provides for a method of exercise and an exercise apparatus for implementing that exercise, in which the muscles of the lower back can be safely exercised and allow for the increased circulation of blood attendant to the proper exercising of all muscles. This increased circulation of blood also promotes healing of damaged or injured muscles and neighboring tissue in the lower back. The exercise further provides for the exercise of these muscles without the danger of hyperextension of the muscles during the exercise.

In yet another series of embodiments, as exemplified, by way of example only and not limitation in U.S. Pat. No. 7,435,207; including FIGS. 1-5. In such a series of embodiments, With reference to FIGS. 1-5, it can be seen that a core muscle apparatus in accordance with this invention is shown. The core muscle apparatus includes a support platform supported by opposed rear support legs and opposed front support legs. The opposed rear support legs are designated as “rear support” legs because they secure to support platform proximate the rear edge thereof, at a rear support cross arm. The opposed front support legs are designated as “front support” legs because, in the operative position, the front support cross arm to which they are secured is positioned proximate the front edge of support platform.

The rear support cross arm is secured between the opposed side walls of the support platform, at support platform pivot assemblies. The opposed rear support legs pivot about the rear support cross arm at their respective support end pivot assemblies to support the apparatus at foot portions engaging the floor. The front support cross arm is pivotally secured to both the opposed front support legs and extends through the opposed support grooves in side walls of the support platform. The opposed front support legs pivot about the front support cross arm at their respective support end pivot assemblies to support the apparatus at the foot portions. The rear support leg is secured to the front support leg at a pivot assembly, and the rear support leg is secured to the front support leg at a pivot assembly. Considering the structure explained hereinabove, it should be appreciated that the front support legs can pivot to a collapsed storable position shown.

While it will be appreciated that various pivoting points of connection (i.e. pivot assemblies) herein could simply consist of cross supports inserted through holes in the appropriate structures, they preferably involve some type of bearing as generally known in the art. This should be understood for all pivoting points of connection in the apparatus.

In the operative position, the rear support legs extend from their support end pivot assemblies to contact the floor at foot portions which are positioned outside of the footprint of the top surface of the support platform. It will be appreciated that the “footprint” of the support platform is defined by the side walls and the rear edge and front edge. The front support legs extend from their support end pivot assemblies to their foot portions, which extend outside of the footprint of the support platform. It should be appreciated that the operative position is reached by pivoting the front support legs with the front support cross arm forced to move through the opposed support grooves. When the front support cross arm reaches the front end of the opposed grooves, the support platform is held substantially horizontal to a ground surface on which the foot portions rest. As described above, in a preferred set of embodiments, the support platform may be adjustably or fixedly inclined to either a somewhat head-down, or head-up, orientation relative to the floor, to which, therefore, it need not be parallel.

When the apparatus is being used, an individual will have much of their weight supported by the support platform, and the weight of the individual will urge the rear support legs and front support legs away from each other. This will urge the front support legs to stay at the front end of the opposed grooves, thus making the apparatus stable for use. Alternatively, the front support legs can be secured in this operative position through positioning knobs.

Positioning knobs can interact with the support platform in any suitable manner for selectively engaging the front support legs in an operative position relative to the support platform. The side wall of the support platform and its interaction with the front support leg and the positioning knob is shown, as by way of example, in the '207 patent. For example, a spring or other biasing member can urge a shaft of the positioning knob to extend through the front support leg and engage side wall. In the operative position wherein the front support cross arm contacts the front end of the groove, the shaft of knob would align with an aperture provided in the side wall, and the biasing member would urge the shaft into the aperture to lock the front support leg relative to the support platform. To release the front support leg, the positioning knob would be pulled against the biasing member to remove the shaft from the aperture and thus permit movement of the front support leg relative to the support platform. The same mechanism could be employed for the front support leg for securing it to the side wall through the positioning knob. It will, however, be appreciated that other mechanisms could be used for stabilizing the apparatus in the operative position.

Upon manipulating positioning knobs to disengage the front support legs from the operative position, the front support legs can be pivoted to place the apparatus in a storage position, wherein the front support cross arm engages the rear end of the opposed grooves, and the support platform pivots at the support platform pivot assemblies store the support platform flush on the rear support legs with the opposed storage grooves in side walls accepting passage of the pivot assemblies. In this collapsed storage position, the opposed storage feet, which extend respectively from rear support leg and rear support leg, can be used to place the apparatus in a free standing position. Wheels may extend above the foot portions and can be used as an aid in moving the apparatus, particularly in the collapsed, storable position.

A possibly inclined top surface of the support platform preferably provides padding. A right hand grip is provided extending from the front of the support platform, proximate the right side wall, and an opposed left hand grip is provided extending from the front of the support platform, proximate the left side wall. When using the device, an individual will place their pelvis at the rear edge of support platform, supporting their torso along the majority of their stomach. The upper torso will be slightly lifted so that the individual can comfortably grip the right and left hand grips. Some individuals will find it comfortable to support themselves somewhat with their elbows on the padding, and others will choose to lay more fully on the padding. The individual will secure his legs to the pendulum (30) assembly, with his hip bending freely at a position slightly rearward of rear edge of the support platform to thereby enable him to move the pendulum (30) assembly forward and rearward in a repetitive motion to perform the exercise for core muscle development. This is fully appreciated from the prior art of U.S. Pat. Nos. 5,356,359 and 6,491,607.

The pendulum (30) assembly may include a pendulum (30) arm that is secured to the rear cross support arm at a sleeve, and extends to a distal end. A pivot arm may extend from proximate the distal end at a pivot assembly, and connects to the resistance transfer apparatus (40), to which it is connected through the pivot assembly. The resistance transfer apparatus (40) preferably includes a central shaft and two or more pad assemblies, such as those at, and mounted to, resistance bars, extending from a central shaft. A foot rest may extend below the central shaft, offset from pad assemblies. An individual will secure his legs to the pendulum (30) assembly by securing his feet between two neighboring pad assemblies, comfortably between pads. The soles of the feet will engage the foot rest.

A weight support may extend from the pendulum (30) arm at selective positions between sleeve and pivot assembly. More particularly, the weight support extends from a weight support sleeve that fits around the pendulum (30) arm, and a position pin extends through the weight support sleeve in a commonly known spring loaded or threaded fashion to be selectively engaged to a desired positioning aperture. Other positioning apertures can be provided. A selected mass of weights can be secured to a weight support. It will be appreciated that, with a selected weight mass and selected weight positioning, various resistances can be effected in the full range of movement of the pendulum (30) arm during the repetitive movement exercise. The pivot assemblies permit smooth movement for individuals of various heights by allowing for movement of resistance transfer assembly relative to pendulum (30) arm.

In yet another series of embodiments, exemplified by way of illustration only and not limitation, in U.S. Pat. No. 7,473,212, including FIGS. 1-5, a support frame that supports the body of an athlete and the moving parts of the apparatus is seen. The frame should preferably be made of structural steel sections to provide a very rigid support structure (10). Conventional bracing may be added, if needed. Movement of the support structure (10) during the exercise is both dangerous and can cause unneeded anxiety in the person who is performing the exercise. The frame preferably rests on supports, raising it slightly off the floor. There is a body support on top of the frame. The body support is preferably padded, and may be fixedly or adjustably angled so that it is not necessarily parallel to the floor.

Attached to the frame adjacent to the body support is a handle bar, preferably extendable and held in the desired place with a pin. For safety and ease of mounting the exercise apparatus, there may be a support bar. The support bar engages a catch fixed to the pendulum (30). Thus the pendulum (30) is prevented from swinging forward (toward the handle bar as the user mounts the exercise apparatus. After the user has mounted, he can pull the support bar forward, thus releasing the pendulum (30).

A pivot bar, which may be located at any location below the body support platform (20), may rotatably retain the pendulum (30). However, for optimal implementation of the exercise method the pivot bar should be located at a point below the location of the waist of the person using the apparatus and at a vertical position near the body support platform (20). In this way, the length of pendulum (30) can be maximized.

The pendulum (30) may be rotatably retained on the pivot bar by one or more bearings, which may be a mere hole in pendulum (30), or preferably one or more ball bearings fitted to the pivot bar. The pendulum (30) is then freely pivotable about the pivot bar) from one of its ends, in a substantially vertical plane.

The pendulum (30) may have three segments. Located on the first segment of the pendulum (30), is a means for engaging a user's legs. Preferably, this is a cross bar, to which straps may be fastened, so that the user's ankles can be held by the straps. Other such means could be chains, ropes, foot pedals, or cups for holding the heels, or some combination.

The pendulum (30) may have a first bend angle of approximately 90 degrees. The pendulum (30) may have a second bend angle of approximately 45 degrees. These angles define a first segment and a second segment of the pendulum (30). The third segment proceeds from the second bend. A stop may be provided on the third segment for attaching conventional circular weights. These weights (and the weight of the pendulum (30) itself) provide the resistance against which the exercise is performed.

Because of the configuration of the pendulum (30) into the three segments, its center of mass is offset from the vertical in a rearward direction. This means that the first segment of the pendulum (30) will be urged forward of the vertical when the support bar is released from the catch. The forward force thus exerted provides greater extension of the lumbar muscles. Also, this configuration allows a maximum range of motion of the pendulum (30) greater than 90 degrees.

As described prior, and as seen in FIGS. 2, 3, 4, and 5 of the '212 patent, the entire range of the preferred exercise method may be seen. At FIG. 2, the user performing the exercise is shown in the proper position (face down or equivalently, anterior side down) to begin the exercise, just before releasing the pendulum (30) by means of the support bar and catch. The torso to the waist is fully supported by body support platform (20), which while shown in the '212 patent as being parallel to the floor, may be inclined to either a relatively head-up or head down position. The user's ankles or lower legs are shown passing through the straps connected to the cross bar. Preferably, the exercise is performed with the ankles passing through the straps. The pendulum (30) is at rest in the vertical position straight below the waist of the user.

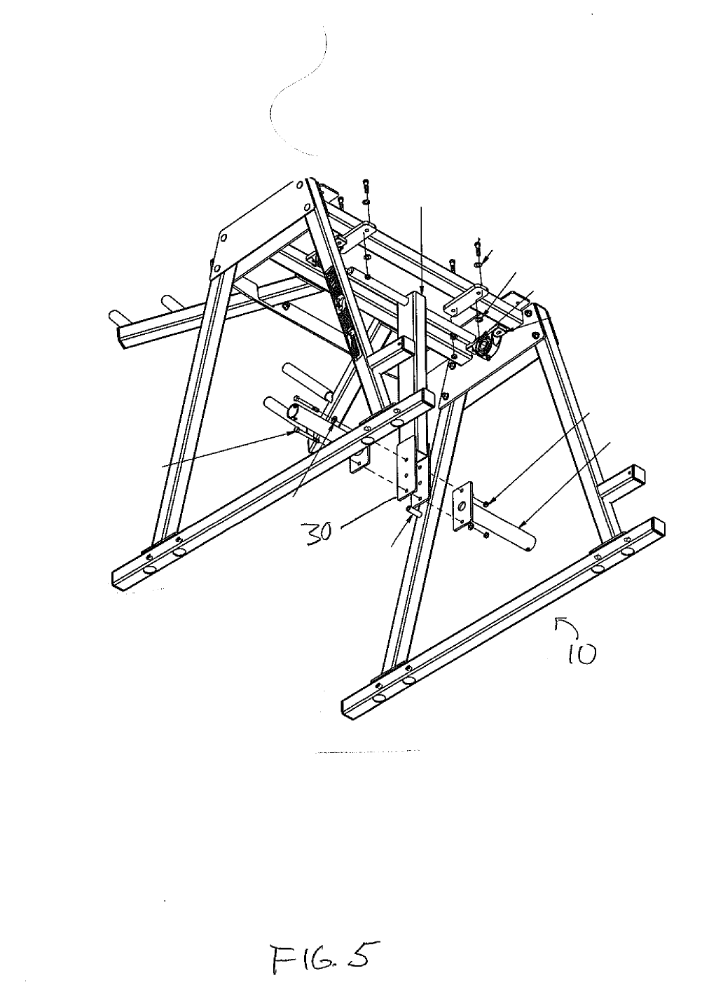

After the support bar is released, the pendulum (30) will swing forward to approximately the position shown in FIG. 5, pulling the legs of the user forward of the vertical. The exercise begins by the user contracting the muscles of the lower back (i.e., spinal erectors and hip flexors) and the gluteus maximus. The legs working against the variable combined weight of pendulum (30) and weights attached to the pendulum (30) are moved through an intermediate position to, at the extreme, a horizontal position.

The user then lowers the legs, not by simply relaxing the muscles, but by lowering the legs using all the muscle groups of the upper legs and lower back. The legs are fully lowered to at least the vertical and then are pushed by the weight of the pendulum (30) forward past the vertical as shown in FIG. 5. Thus, the total range of motion of the legs is greater than 90 degrees. After the user has resisted the movement of his legs as far past the vertical as he can, the exercise begins again by contracting the muscles and pushing the legs back to the horizontal. The exercise is then repeated the number of times desired by the user.

The exercise is best performed as a smooth continuous action through the iterations. At all points in the exercise, the legs and correspondingly the affected muscles only push and are never pulled from one station to the next. The result is that hyperextension of muscles is avoided and the injured muscles of the lower back are permitted to receive an increased flow of blood. Additionally, for a user with an otherwise healthy lower back, the exercise builds up those lower back muscles thus avoiding future injury.

Increasing lower back strength is also critical to power lifting. The most common injuries to power lifters are those of the lower back. However, by regularly using the exercise disclosed, users who lift very heavy weights for sport or in competition, also known as power lifters, can train to greater weight levels while avoiding lower back injuries which are not only counter-productive to a proper training program due to lost training time, but also could lead to permanent lower back injuries that are also common among power lifters.

In yet another series of embodiments, seen by way of example only and not limitation, in U.S. Pat. No. 8,529,413, including FIGS. 1-8, an exercise apparatus is seen that has a frame, preferably made of steel for strength. The frame is supported by legs. The top of the frame preferably has a padded body-support platform to support the user's body. This platform may be fixed in position or may be adjustable in a somewhat head-up or head-down position, or which may be fixedly similarly inclined. This embodiment has optional handgrips to assist the user in mounting the apparatus and holding himself or herself in exercise position; that is, belly down, with the legs rearward.

There may be a right pendulum (30) and a left pendulum (30) connected to the frame at pivots. The pivots may be merely holes in a flange engaging a pin, but are preferably ball bearings, allowing the pendulum (30)s to pivot independently of one another. Each of the right pendulum (30) and the left pendulum (30) may comprise an arm; the arm pivotably connects the respective pendulum (30)s to the frame at the pivots.

In a first sub-set of embodiments, each arm may be connected to a resistance transfer apparatus (40) by means of a pivoting linkage. The connection of each pivoting linkage to the arms is preferably adjustable by means of a sleeve and pin combination, but the pivoting linkage may be connected directly to the arm. The resistance transfer apparatus (40) comprises a second arm. This second arm preferably has padded bars extending approximately perpendicular to it, to engage the lower legs of the person exercising, generally by holding the bars with the ankles, thus working the back muscles against the resistance of raising and lower the pendulum (30)s. An optional skid may be connected to the second arm to lift either resistance transfer apparatus (40) off the ground and make it easier for the person exercising to slide his or her feet into place.

A transverse rod may be preferably provided so that the user can place his or her foot thereon to work the gluteals and hamstrings. Each arm preferably has some means for adding resistance to the movement of the right pendulum (30) and left pendulum (30). In the figures of the '413 patent, by way of example only, this means is shown as a post connected approximately perpendicular to the respective arms, for supporting conventional weight disks. The frame preferably has foot steps connected to it to assist the user in mounting the apparatus and assuming the correct position for exercise.

In a second sub-set of embodiments, a strap may be connected to the each of the arms of the respective right pendulum (30) and left pendulum (30). The straps, as an alternate resistance transfer apparatus (40), may be connected whether the previously disclosed resistance transfer apparatus (40) is present or not. The person exercising can slip his or her ankles into the straps and work against the resistance afforded by the weights.

In a third sub-set of embodiments, the pivoting linkage may be replaced by a bar comprising two sections. A first section may be pivotably connected by a pivot to one of the respective arms of the right pendulum (30) or left pendulum (30). The first section has spaced holes. A second section may be connected as a sleeve over the first section and adjustably locked thereto by a pin fitting into one of the adjusting holes. In this way, the total length of the respective pendulum (30)s can be adjusted by moving the resistance transfer apparatus (40) of this embodiment nearer or farther from the end of the respective arms. As shown in FIG. 4 of the '413 patent, the resistance transfer apparatus (40) of this embodiment is connected to the second section at a pivot.

As to use, using the embodiments discussed above, a user may mount the apparatus so that his or her torso to the waist is fully supported by body support platform (20), which as stated may be parallel or non-parallel to the floor. The user's lower legs pass through the resistance transfer apparatus (40). Weights may be put in place on the posts. Preferably, the exercise is begun with the ankles passing through the ankle pads of the resistance transfer apparatus (40). At this point, the right pendulum (30) and the left pendulum (30) are substantially vertical with respect to the body support platform (20).

The exercise begins by the user contracting the muscles of the lower back (i.e., spinal erectors and hip flexors) and the gluteus maximus. The legs, working separately against the variable combined weight of the pendulum (30)s and thus the weights, are moved upward to a substantially horizontal position with respect to the body support platform (20), bringing the pivoting arms upward as they pivot on their respective individual pivots.

In one example, the pivoting linkage connecting the pivoting arms and the resistance transfer apparatus (40) allows the pivoting arms and the attached ankle pads to move so as to keep the pads engaged with the user's legs, preferably at the ankles.

The user then lowers the legs, not by simply relaxing the muscles, but by lowering the legs using all the muscle groups of the upper legs and lower back. The legs are fully lowered to at least the vertical and then are pushed by muscle action forward past the vertical. Thus, the total range of motion of the legs is greater than 90 degrees. After the user has pushed the legs as far past the vertical as he or she can, the exercise begins again by contracting the muscles and pushing the legs back to the horizontal. The exercise is then repeated the number of times desired by the user exercising.

The exercise is best performed as a smooth continuous action through the iterations. At all points in the exercise, the legs and correspondingly the affected muscles only push and are never pulled from one station to the next. The result is that hyperextension of muscles is avoided and the injured muscles of the lower back are permitted to receive an increase flow of blood. Additionally, in a user with an otherwise healthy lower back, the exercise builds up those lower back muscles thus avoiding future injury.

Still another series of embodiments, exemplified but shown by way of example and not limitation only in U.S. Pat. No. 9,375,599, including FIGS. 1-10, shows, generally, support legs that are connected by support cross arms, and a body support platform (20) inclinable relative to a parallel position to the floor, to form a user support structure (10). A pendulum (30), described below, depends from the user support structure (10). It is preferred that the body support platform (20) include padding for comfort. Handholds for the user may optionally be provided.

There may be means for providing assistance and resistance to the pendulum (30), as discussed in detail below. There may be a pivot bar, located below the body support platform (20), which rotatably retains the pendulum (30). For optimal implementation of the exercise method, the pivot bar should be located at a point approximately below the waist of the person using the apparatus and at a vertical position near the body support platform (20).

The pendulum (30) may be rotatably retained on the pivot bar on one or more bearings fitted to the pivot bar. The bearings may be equivalently mounted on support cross arms or elsewhere on the supporting structure to thereby rotatably retain the pivot bar. In any embodiment, pendulum (30) is then freely pivotable about the pivot bar, as shown, in a substantially vertical plane.

The pendulum (30) may be a composite structure. A resistance transfer apparatus (40) may be pivotably attached to the pendulum (30) at a connector. The resistance transfer apparatus (40) preferably has two or more pads extending laterally from the axis of the resistance transfer apparatus (40), which pads are preferably rotatably mounted, to thus comfortably retain the user's ankles as the exercise is executed. The resistance transfer apparatus (40) may retain the user's legs anywhere along their length, but the optimum position is at the ankles. It is convenient to provide additional padded supports along the pendulum (30), but nearer the pivot bar, to give additional support to the user's upper legs.

As stated, many individuals, however, cannot perform the exercise without assistance. Such persons require an assisted lift of the legs, at least for the concentric portion of the lift. Users unable to lift their legs up can still go through the complete range of motion with the assistance. The eccentric portion of the movement, or the lowering of the legs, may be assisted by decreasing the assist provided for raising the legs in the concentric portion of the exercise. As will be discussed in more detail below, the provision of assistance to the user prevents the buildup of momentum as well as assisting out-of condition users to enter and complete the exercise. Also as discussed below, the range of motion may be controlled by a practitioner and not by the user.

The body support platform (20) may pivot, as will be explained later, on body support rods extending from either side of the frame. A first actuator and second actuator, cooperating together, provide assistance to the user in raising and lowering the user's legs, and a third actuator provides resistance to the movements made by the user. First actuator and second actuator turn a gear set with a crank arm. Equivalently, the gear set could be a sprocket and chain. The gear set rotates the pivot bar, causing the pendulum (30) to move accordingly. The actuators will be discussed in this disclosure as pneumatic, but may equivalently be electric or hydraulic. The embodiment illustrated uses two actuators, a first actuator and a second actuator, to obtain the force required to provide active assistance to the user. The reader should note, however, that in other embodiments only one such actuator for assistance will be needed, if a sufficiently powerful single actuator is adaptable to be mounted within the apparatus. Also, the side view figures here will generally identify only first actuator for clarity.

Since the user's legs are constrained by the resistance transfer apparatus (40) connected to the pendulum (30), the user's legs may either be assisted in their movement by the first actuator and second actuator, or their movement may resisted by movement of the third actuator, depending on the pneumatic pressures communicated to the actuators according to settings made at the control panel.

The disclosed improvements safely and effectively provide exercise benefits to those users who lack the strength or control to perform the exercise on their own, without assistance. This is accomplished by providing active assistance to the movement of the user's legs and back through all phases of the exercise. The active assistance is provided for raising the pendulum (30) with the user's legs engaged by means of the first actuator and second actuator, acting together upon the gear set, turning a pivot bar.

The active resistance to the user's movements as the user attempts to move his legs back to the starting position is provided by third actuator, also connected to turn the pivot bar. Generally, the third actuator will be sufficiently powerful to provide the needed resistance without transmission of torque through a gear set. The first actuator and the second actuator (or a single such actuator), and the third actuator are controlled by pneumatic valves (or hydraulic valves or electric motor controls in other embodiments) preferably located in a control station adjacent to or connected to the frame of the apparatus. Preferably, the control station is operated by a practitioner, such as a physician or a physical therapist.

An air pressure gauge may show the amount of pressure applied to the actuators, and thus the amount of force exerted by the actuators, to allow the practitioner to note and record progress by the user in both lifting his or her legs and in applying resistance. A command switch is provided to command either up or down movement of the pendulum (30). A first lever switch continuously varies the amount of pressure (and thus force) causing assisted movement (up or down), and a second lever switch continuously varies the amount of pressure (and thus force) causing resistance to movement (up or down).

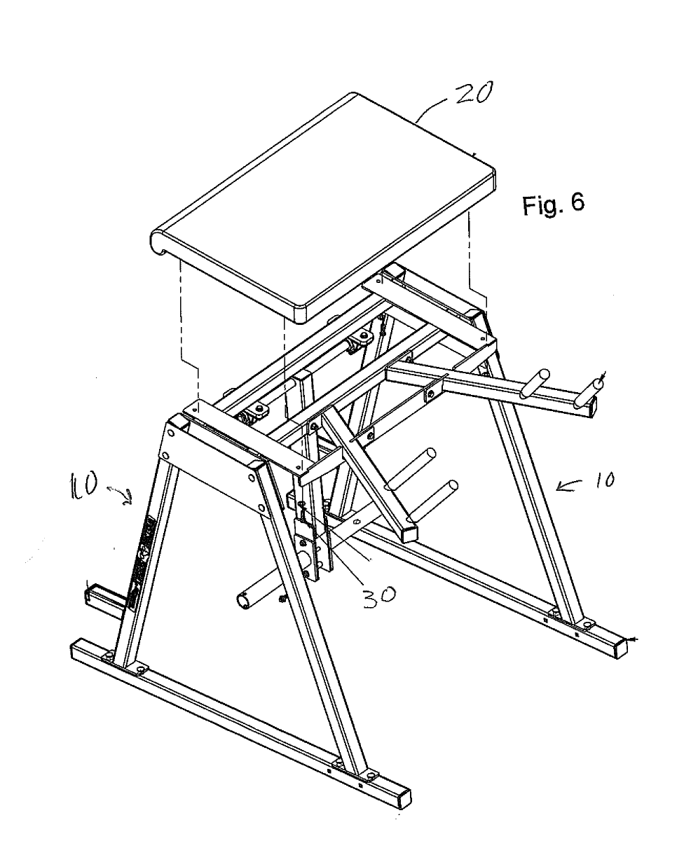

The resistance transfer apparatus (40) and its rotatable connection to the pendulum (30) permits the user's legs to move up to the horizontal and back past the vertical during the exercise. In this disclosure, the “vertical” position of a user's legs is substantially as depicted in FIG. 6 of the '599 patent. A “horizontal position of the user's legs is substantially as depicted in FIG. 8. A movement said to be “upward” or “upwardly” is a movement from the vertical position toward the horizontal position, and a movement said to be “downward” or “downwardly” is a movement from the horizontal position toward the vertical position. (Similar terms are used for the position of the pendulum (30)). The static weight of the pendulum (30) does not come into play or weight the user's ankles until the exercise is begun with the pendulum (30) vertical.

In a starting position of the user's legs, the user engages the resistance transfer apparatus (40). The user then raises his or her legs to the approximately horizontal position and then lowers his or her legs back to the starting position and pushed slightly past the starting position; thus the total range of motion is greater than 90 degrees. After the user has pushed the legs as far past the vertical as he or she can, the exercise begins again by contracting the muscles and pushing the legs back to the horizontal. Preferably, the range of motion allowed should be approximately at least 135 degrees. The exercise is then repeated the number of times desired. In one embodiment the support platform may be tilted by means of an actuator, thus making it easier for a user to mount and start the exercise, also to dismount. Advantageously, the support platform should allow a tilt of about 0-18 degrees.

The exercise is best performed as a smooth continuous action through the iterations. At all points in the exercise, the legs and correspondingly the affected muscles only push and are never pulled from one station to the next. The result is that hyperextension of muscles is avoided and the injured muscles of the lower back are permitted to receive an increase flow of blood. Additionally, in a user with an otherwise healthy lower back, the exercise builds up those lower back muscles thus avoiding future injury.

In addition to the embodiments discussed above, the drawings appended to this specification may indicate elements and details additional to or different to those in the text of this specification, and any such embodiments are specifically intended to be disclosed, even if they may conflict with certain other embodiments. In a similar vein, this specification incorporates all the disclosures of U.S. Pat. Nos. 5,356,359; 6,491,607; 7,435,207; 7,473,212; 8,529,413; and 9,375,599; as well as those of U.S. patent application Ser. Nos. 14/253,159; 15/441,468; and Ser. No. 15/417,819.

Numerous alterations, modifications, and variations of the preferred embodiments disclosed herein will be apparent to those skilled in the art and they are all anticipated and contemplated to be within the spirit and scope of the disclosed specification. For example, although specific embodiments have been described in detail, those with skill in the art will understand that the preceding embodiments and variations can be modified to incorporate various types of substitute and or additional or alternative materials, relative arrangement of elements, order of steps and additional steps, and dimensional configurations. Accordingly, even though only few variations of the method and products are described herein, it is to be understood that the practice of such additional modifications and variations and the equivalents thereof, are within the spirit and scope of the method and products as defined in the following claims. The corresponding structures, materials, acts, and equivalents of all means or step plus function elements in the claims below are intended to include any structure, material, or acts for performing the functions in combination with other claimed elements as specifically claimed.

I claim:

1. An apparatus for lower back exercise, the apparatus comprising:
a support structure, the support structure further comprising a body support platform inclinable relative to an imaginary line parallel to a support surface;
a pendulum, the pendulum pivotably connected to the support structure and depending therefrom;
a first actuator connected to the pendulum to cause the pendulum to move upwardly or downwardly to assist movement of the legs of a user engaging the pendulum;
a second actuator connected to the pendulum to exert resistance to movement of the pendulum initiated by the user; and
controls operably connected to the first actuator and the second actuator effective to regulate the motion of the pendulum upwardly or downwardly while the user's body is disposed on the body support platform and the user's legs engage the pendulum.

2. An apparatus for lower back exercise comprising:
a. a support structure, the support structure further comprising a body support platform supported by the support structure;
b. the body support platform pivotably connected to the support structure;
c. at least one adjustment flange connected to the body support platform, the adjustment flange having at least two holes for receiving a locking pin;
d. a locking pin for engaging a hole in the adjustment flange, whereby the body support platform is removably locked into a pre-determined angle with respect to the horizontal;
e. a pendulum, the pendulum having an upper portion and a lower portion, the upper portion of the pendulum having a bearing; the pendulum being pivotably connected to the support structure with the bearing, below the body support platform; the pendulum further comprising: (1) a frame connected to the lower portion of the pendulum; (2) one or more weights removably connected to the frame; (3) a sleeve slideably engaging the pendulum; and, (4) an adjustable lock for adjustably fixing the sleeve to the pendulum; and,
f. a resistance transfer apparatus pivotably connected to the sleeve by means of a mounting assembly; the mounting assembly comprising a fork and a pin for pivotably connecting to the sleeve; the resistance transfer apparatus pivoting in a plane substantially parallel to that of the pendulum while engaging the lower legs of a person exercising; the resistance transfer apparatus further comprising: (1) a central bar connected to the mounting assembly; and, (2) at least one pair of resistance rods connected to the central bar and disposed perpendicular to the central bar on opposite sides thereof, for engaging the legs of a person exercising; and, (3) one or more pads; the pads having a circular cross-section and concentric holes; the holes sized so that the pads each receives one of the resistance rods.

3. A method for exercising the lower back and upper legs comprising the steps of:
(a) disposing a person anterior side down on a body support platform so that the stomach and chest areas are supported and maintained above the ground and such that the legs are not supported by the platform but hang freely and vertically down from the edge of the platform;
(b) maintaining the body support platform above the ground with a support structure inclined relative to an imaginary line drawn parallel to a support surface, and wherein the support structure retains the body support platform at least high enough that the legs and feet of the person are maintained above the ground;
(c) adjusting the angle of the body support platform with respect to the horizontal by pivoting the body support platform to a pre-determined angle and locking the body support platform in that position by means of an adjustment flange and locking pin;
(d) providing a pendulum which is pivotably connected to the support structure and providing the other end of the pendulum with a mounting assembly;
(e) providing a resistance transfer apparatus connected to the pendulum by means of the mounting assembly; the resistance transfer apparatus having resistance rods;
(f) placing the legs of the person against the resistance rods so that the resistance transfer apparatus connects the lower legs of the person to the lower end of the pendulum;
(g) lifting the legs to a horizontal position against the weight resistance of the pendulum by means of the resistance transfer apparatus wherein the force of lifting is provided by the contraction of the gluteus maximus, and the erector and flexor muscles of the lower back; and
(h) lowering the legs through the vertical rest position and using those same muscle groups to push the legs past the vertical in a total motion substantially greater than 90 degrees repeating the lifting and lowering steps to form an exercise regimen.
